(19) United States
(12) Patent Application Publication
(10) Pub. No.: US 2010/0141231 A1
(43) Pub. Date: Jun. 10, 2010

(54) Igniter voltage compensation circuit

(75) Inventor: Glenn A. Duchene, Marlborough, MA (US)

Correspondence Address: EDWARDS ANGELL PALMER & DODGE LLP, P.O. BOX 55874, BOSTON, MA, 02205, US

(73) Assignee: Saint-Gobain Ceramics & Plastics, Inc., Worcester, MA (US)

(21) Appl. No.: 12/592,538

(22) Filed: Nov. 25, 2009

Related U.S. Application Data
(60) Provisional application No. 61/118,631, filed on Nov. 30, 2008.

(51) Int. Cl. G05F 3/04

(52) U.S. Cl. 323/300

(57) ABSTRACT

Featured is igniter control circuitry that reduces the line voltage to the igniter and which maintains the igniter voltage relatively stable. More particularly, there is featured, a thyristor-based phase control circuit that reduces the RMS voltage being applied to an igniter when it is connected to the AC line or line voltage. The circuitry also is configured so that it opposes changes in line voltage such that the igniter voltage remains relatively stable when the line voltage increases or decreases relative to its nominal level. Such control circuitry includes a dual diac configuration, a relation oscillator configuration and one embodying both dual diac and relation oscillator configurations.

This application claims the benefit of U.S. Provisional Application Ser. No. 61/118,631 filed Nov. 30, 2008, the teachings of which are incorporated herein by reference.

### FIELD OF INVENTION

The present invention generally relates to circuitry, systems and methods for controlling ignition of combustible material such as natural gas or propane, more particularly to circuitry for controlling ignition (including re-ignition of gas) when using electrical resistance igniters, even more particularly to circuitry for controlling the voltage being applied to the electrical resistance igniter.

### BACKGROUND OF THE INVENTION

There are a number of appliances such as cooking ranges and clothes dryers, water heaters and furnaces in which a combustible material, such as a combustible hydrocarbon (e.g., propane, natural gas) is mixed with air (i.e., oxygen) and continuously combusted within the appliance, water heater or furnace so as to provide a continuous source of heat energy. This continuous source of heat energy is used for example to cook food, dry clothes and heat water to supply a source of running hot water or heat air or water to heat an apartment, house or other structure (e.g., barn, work shop, or garage).

Because this mixture of fuel and air (i.e., fuel/air mixture) does not self-ignite when mixed together, an ignition source is provided to initiate the combustion process and to continue operating until the combustion process is self-sustaining. In the not too distant past, the ignition source was what was commonly referred to as a pilot light in which a very small quantity of the combustible material and air was mixed and continuously combusted even while the heating apparatus or appliance was not in operation. For a number of reasons, the use of a pilot light as an ignition source was done away with and an igniter is used instead.

An igniter is a device that creates the conditions required for ignition of the fuel/air mixture on demand, including spark-type igniters such as piezoelectric igniters and hot surface-type igniters or electrical resistance igniters such as silicon carbide hot surface igniters. Spark-type igniters produce an electrical spark that ignites gas and advantageously provide very rapid ignition, which is to say, ignition within a few seconds. Problems with spark-type igniters, however, include among other things the electronic and physical noise produced by the spark.

With hot surface igniters, such as the silicon carbide hot surface igniter, the heating tip or element is resistively heated by electricity to the temperature required for the ignition of the fuel/air mixture. Thus, when the fuel/air mixture flows proximal to the igniter it is ignited. This process is repeated as and when needed to meet the particular operating requirements for the heating apparatus/appliance. Hot-surface-type igniters are advantageous in that they produce negligible noise in comparison to spark-type igniters. Hot surface-type igniters, however, can require significant ignition/warm-up time to resistively heated the resistance igniter sufficiently to a temperature that will ignite gas.

There are several manufacturers of igniters. The igniter from any one manufacturer, because of its particular material composition, mass, and physical configuration, will generally heat up at a different rate to a different final temperature than an igniter from another manufacturer. For example, when energized at 115 volts, igniters from one manufacturer may heat up to a temperature sufficient to ignite gas, approximately 1600° F., in approximately 5 seconds, and to a relatively stable final temperature of approximately 2500° F. when energized for 20 seconds or longer. An igniter from another manufacturer may require more or less time to heat up to 1600° F. and may attain a lower or higher final temperature. The rate of temperature change and the final temperature attained also depends on the value of the applied voltage. Specifically, when the applied or line voltage is less than 115 volts, the igniter heats up slower and attains a lower final temperature than when energized at 115 volts; when the applied voltage is greater than 115 volts, the igniter heats up faster and attains a higher final temperature.

These lower and higher line or applied voltages, while not generally impacting the capability of the igniter to ignite the fuel mixture, can lead to the igniter having a shorter operational life than the case where the applied voltage was being maintained at a desired voltage. This becomes particularly important when the line voltage being provided to the appliance, water heater or furnace is greater than the operational voltage requirements for an igniter. In such cases, control circuitry or control logic is provided that causes the line voltage to be reduced to a value that can support the functionality of the igniter. In such cases, fluctuations in the line voltage can create conditions that affect the operational life of the igniter.

Hot surface ignition systems typically include a control module that, among other functions, controls the voltage/current being applied to the igniter. In the case of such systems that embody a igniter whose operational voltage requirements are less than the line voltage, such controlling includes reducing the voltage from the power line so that the voltage being applied to the igniter satisfies the igniters operational voltage requirements.

There is shown in FIG. 1 a schematic view of a thyristor-based phase control circuit 10 that reduces the RMS voltage applied to an igniter 2 when the igniter is connected to the AC line 4 or line voltage. The illustrated control circuit 10 is based upon a simple well-known phase control configuration (such as that used in light dimmers). The control circuit includes a triac 12 or alternistor, diac 14, resistor 16, and a capacitor 18, which are arranged as shown in FIG. 1. As is known to those skilled in the art, a single Quadrac can be used to replace the diac and triac to further simplify the assembly. In the control circuit 10, the diac 14 and triac 12 are initially in a high-resistance state and thus current is not allowed to flow. The resistor 16 and capacitor 18 are arranged to form a series RC circuit that is connected across the AC line 4.

In the illustrated circuit 10, the igniter 2 has very little effect on the charging voltage of the capacitor 18 because its resistance (typically less than 500 Ohms) is much lower than of the resistor 16; which is typically around 100 times higher than that of the igniter. Thus, the voltage being developed across the capacitor as the line voltage goes positive, is delayed relative to the line voltage.

When the capacitor 18 charges to the “breakover voltage” (V_{Bo}) of the diac 14, the resistance of the diac suddenly drops such that much of the charge on the capacitor 18 is dumped into the gate 11c of the triac 12 to fire (i.e., switch on) and apply current to the igniter 2. When the triac 12 switches on, the resistance between terminals MT2 11a and MTI 11b drops to a very low level. When the diac's current drops below its “holding” current (as it will when charge in the capacitor 18 becomes depleted), the diac 14 reverts back into its high-resistance state. Similarly, when the triac's current drops below its “holding” current (as it will when the line voltage nears zero again), the triac 12 reverts back into its high-resistance state.

Since the diac 14 and triac 12 are AC devices, the same series of events occurs during the negative half of the AC cycle. Thus, the igniter 2 is only on during a fraction of each AC cycle, and the size of that fraction is determined by the value of the resistor 16. The value of the capacitor 18 is typically fixed in order to fix the amount of charge dumped into the gate of the triac 12.

As is known to those skilled in the art, a chief disadvantage of this well known configuration is that the charging rate of the capacitor 18 is affected by the line voltage. For example, when the line voltage is increased, the capacitor 18 charges the diac to its “breakover voltage” (V_{Bo}) faster as compared to the when nominal line voltage is provided. The igniter voltage is directly increased because of the increased line voltage, and is increased even further because of the triac 12 being switched on earlier during each AC half-cycle. This further increase in igniter voltage further increases the igniter temperature and thus, tends to shorten its life. Conversely, when the line voltage is reduced, the igniter voltage is further reduced because the capacitor 18 takes longer to charge the diac to V_{Bo}. This further reduction in igniter voltage correspondingly decreases the temperature of the igniter 2, which reduces in turn the igniter's effectiveness in achieving ignition.

It thus would be desirable to provide methods, control circuitry and/or control devices that control the RMS voltage being applied to an igniter so it is in a desired range for the igniter to be capable of igniting the fuel or combustible mixture (e.g., natural gas and air). It also would be desirable to provide such methods, control circuitry and/or control devices that regulate the voltage being applied to the igniter so as to compensate for voltage fluctuations, in at least one of or both of a positive or negative direction, in the power line providing electrical power to the igniter. It would be particularly desirable to provide such methods, control circuitry and/or devices that would control igniter energization so as to extend the operational life of the igniter in comparison to the operational life for igniters being controlled by prior art control devices.

### SUMMARY OF THE INVENTION

The present invention features an igniter control circuit that reduces the line voltage to the igniter and which maintains the igniter voltage relatively stable. More particularly, there is featured, a thyristor-based phase control circuit that reduces the RMS voltage being applied to an igniter when it is connected to the AC line or line voltage. The circuitry also is configured so that it opposes changes in line voltage such that the igniter voltage remains relatively stable when the line voltage increases or decreases relative to its nominal level. Also featured are methods for controlling voltage being applied to an igniter and ignition systems embodying such a circuit.

According to one aspect of the present invention, there is featured a voltage control circuit for an igniter that controls the voltage being applied to the igniter that includes a triac, a first diac electrically coupled to the triac such that current is provided to the triac when the diac fires and an RC circuit element in which the capacitor is arranged to feed voltage to the first diac. Such a control circuit includes a resistor/diac element in which the voltage from such an element is supplied to the RC element for charging of the capacitor.

In further embodiments/aspects, the RC circuit element includes a first resistor and capacitor that are arranged in series and the resistor/diac element includes a second resistor and a second diac that are arranged in series.

In yet further aspects/embodiments, the second resistor and the second diac are connected in series so as to be across the source of line voltage. Also, the RC circuit element can include a first resistor and capacitor in series arrangement and be connected to a point electrically between the second resistor and the second diac.

In yet further aspects of the present invention, there are featured methods for controlling voltage being applied to an igniter. In its broadest aspects such a method includes providing a first circuit element that is configured so voltage being applied to the igniter is at about a nominal value; and regulating inputted line voltage using the first circuit element so as to mitigate changes in line voltage causing changes in voltage being applied to the igniter. In yet further aspects, such a method further includes providing a second circuit element that is configured to adjust the voltage being applied to the igniter so as to be at a voltage less than the inputted line voltage; and adjusting the inputted line voltage so as to be at about a desired voltage to be applied to the igniter.

In yet further aspects/embodiments of the present invention, such providing first and second circuit elements includes providing a voltage control circuit; and the method further includes electrically coupling the voltage control circuit to the igniter. The provided voltage control circuit can embody any of the features described herein, or any combination of such features.

In yet further aspects/embodiments of the present invention, such a voltage control circuit can be configured so as to further include a relaxation oscillator circuit and a bleed circuit as described herein. In particular embodiments, the relaxation oscillator circuit is configured to repetitively create N signal outputs during each half AC cycle of the line voltage source, N is an integer greater than 2. The bleed circuit is operably coupled to the relaxation oscillator circuit and operably coupled to the RC circuit element. The bleed circuit also is configured and arranged so as to reduce an amount of charge being provided to the first capacitor responsive to the output signals of the relaxation oscillator circuit. The methods related thereto also are adaptable so as to include the methodology embodied with such relaxation oscillator circuits and bleed circuits.

According to yet another aspect of the present invention there is featured a voltage control circuit for an igniter that controls the voltage being applied to the igniter that includes a triac, a first diac electrically coupled to the triac such that current is provided to the triac when the first diac fires, and an RC circuit element including a first capacitor which is arranged to feed voltage to the first diac, a relaxation oscillator circuit and a bleed circuit. The relaxation oscillator circuit is configured to repetitively create N signal outputs during each half AC cycle of the line voltage source, N is an integer greater than 2. The bleed circuit is operably coupled to the relaxation oscillator circuit and to the RC circuit element. The bleed circuit also is configured and arranged so as to reduce an amount of charge being provided to the first capacitor responsive to the output signals of the relaxation oscillator circuit.

In particular embodiments, the RC circuit element includes a first resistor, and the first resistor and the first capacitor are arranged in series and/or the first resistor and the first capacitor are connected across a source of line voltage. In further embodiments, the bleed circuit is connected to a point electrically between the first resistor and first capacitor.

In yet more particular embodiments, the bleed circuit includes a fifth resistor and a switching element that are arranged so as to be in series. The switching element is operably coupled to the relaxation oscillator circuit so as to selectively open and close responsive to the relaxation oscillator circuit. When an output signal is received from the relaxation oscillator circuit, the switching element causes current to be drawn through the fifth resistor and away from the first capacitor.

In yet more particular embodiments, the relaxation oscillator circuit includes an RC circuit element including a third resistor and a second capacitor. The third resistor and second capacitor are configured and arranged so the second capacitor is capable of being charged N times during each half AC cycle of the line voltage source, N being an integer greater than 2.

In yet more particular embodiments; the relaxation oscillator circuit further includes a third diac, at least one photodiode, and a fourth resistor. The third diac, the at least one photodiode and the fourth resistor are arranged so as to be in series. In further embodiments, the series arrangement of the third diac, the at least one photodiode and the fourth resistor is arranged so as to be in parallel arrangement with the second capacitor. In yet more particular embodiments, the relaxation oscillator circuit further includes a plurality of photodiode.

In yet more particular embodiments, the bleed circuit switching element includes a photosensitive transistor. Each of the at least one photodiode or each of the plurality of photodiodes is optically coupled to the photosensitive transistor. The photosensitive transistor causes the switching element to selectively open and close responsive to the optical signals generated by each of the at least one photodiode or each of the plurality of photodiodes.

In yet further particular embodiments, one of the plurality of photodiodes is configured to output optical signals during a half AC cycle of the line voltage source and the other of the plurality of photodiodes is configured to output optical signals during the other half AC cycle of the line voltage source. In further embodiments, the switching element includes a plurality of diodes that are arranged so that current flows through the fifth resistor during either of the two half AC cycles.

In yet more particular embodiments, when the second capacitor is charged to the breakover voltage of the third diac, the third diac fires causing current to flow through each of the at least one photodiodes thereby causing an optical signal to be outputted therefrom. Also, when the third diac's current drops below its holding current, the third diac reverts to its high-resistance state and the second capacitor again begins to charge.

According to yet another aspect of the present invention, there is featured a method for regulating speed of a motor. Such a method includes providing a circuit element that is configured so as to control voltage being applied to the motor so it is maintained at about a nominal value; and regulating the line voltage being inputted to the motor using the first circuit element so as to mitigate changes in line voltage causing changes in voltage being applied to the motor. The provided voltage control circuit being provided can embody any of the features described herein, or any combination of such features.

In yet further aspects of the present invention there is featured an ignition system that is electrically coupled to a voltage source, which includes an igniter and a voltage control circuit electrically coupled to the igniter for controlling the voltage being applied to the igniter. The provided voltage control circuit being provided can embody any of the features described herein, or any combination of such features.

Other aspects and embodiments of the invention are discussed below.

### DEFINITIONS

The instant invention is most clearly understood with reference to the following definitions:

DIAC: A diac or diode for alternating current shall be understood to mean a bidirectional trigger diode that conducts current only after its breakdown voltage has been exceeded momentarily. When this occurs, the resistance of the diode abruptly decreases, leading to a sharp decrease in the voltage drop across the diode and, usually, a sharp increase in current flows through the diode. The diode remains “in conduction” until the current flow through it drops below a value characteristic for the device, called the holding current. Below this value, the diode switches back to its high-resistance (non-conducting) state. When used in AC applications this automatically happens when the current reverses polarity. The behavior is typically the same for both directions of current flow.

Diacs are a form of thyristor but without a gate electrode. They are typically used for triggering both thyristors and triacs—a bidirectional member of the thyristor family. Diacs are also called symmetrical trigger diodes due to the symmetry of their characteristic curve. Because diacs are bidirectional devices, their terminals are not labeled as anode or cathode but as A1 and A2 or MT1 (“Main Terminal”) and MT2.

TRIAC: A triac or triode for alternating current shall be understood to be an electronic component approximately equivalent to two silicon-controlled rectifiers (SCRs/tyristors) joined in inverse parallel (paralleled but with the polarity reversed). Formal name for a Triac is bidirectional triode thyristor. This results in a bidirectional electronic switch which can conduct current in either direction when it is triggered (turned on). It can be triggered by either a positive or a negative voltage being applied to its gate electrode (with respect to A1, otherwise known as MT1). Once triggered, the device continues to conduct until the current through it drops below a certain threshold value, such as at the end of a half-cycle of alternating current (AC) mains power. This makes the triac a very convenient switch for AC circuits, allowing the control of very large power flows with milliampere-scale control currents. In addition, applying a trigger pulse at a controllable point in an AC cycle allows one to control the percentage of current that flows through the triac to the load (so-called phase control).

Low power triacs are used in many applications such as light dimmers, speed controls for electric fans and other electric motors, and in the modern computerized control circuits of many household small and major appliances.

RELAXATION OSCILLATOR: A relaxation oscillator is an oscillator in which a capacitor is charged gradually and then discharged rapidly. It is usually implemented with a resistor or current source, a capacitor, and a “threshold” device such as a neon lamp, diac, unijunction transistor, or Gunn diode. For simplification below, a single “threshold” device will be replaced by a set of comparators and a SR Latch. The capacitor is charged through the resistor, causing the voltage across the capacitor to approach the charging voltage on an exponential curve.

In parallel with the capacitor is the threshold device. Such devices don't conduct at all until the voltage across them reaches some threshold (trigger) voltage.

They then conduct heavily, quickly discharging the capacitor. When the voltage across the capacitor drops to some lower threshold voltage, the device stops conducting and the capacitor can begin charging again, repeating the cycle. The electrical output of a relaxation oscillator is usually a sawtooth wave.

### BRIEF DESCRIPTION OF THE DRAWING

For a fuller understanding of the nature and desired objects of the present invention, reference is made to the following detailed description taken in conjunction with the accompanying drawing figures wherein like reference characters denote corresponding parts throughout the several views and wherein:

FIG. 1 is a schematic view of a conventional thyristor-based phase control circuit for an igniter.

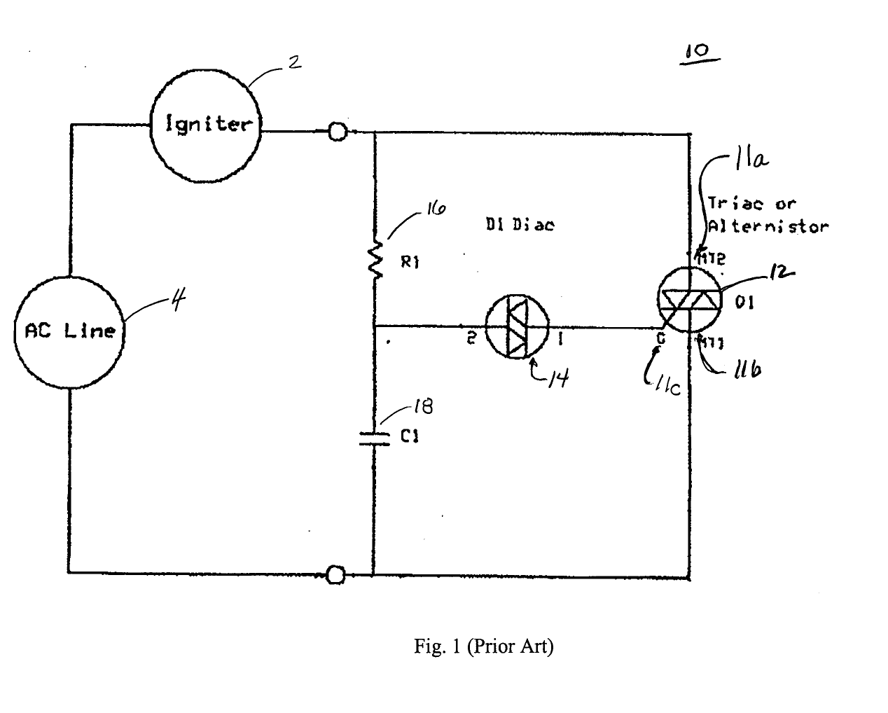

FIG. 2A is a schematic view of a thyristor-based phase control circuit for an igniter according to an aspect of the present invention.

FIG. 2B is a schematic view of a thyristor-based phase control circuit for an igniter according to another aspect of the present invention.

FIG. 2C is a schematic view of a thyristor-based phase control circuit for an igniter according to yet another aspect of the present invention.

FIGS. 3A, B are tabulations of preliminary test results for a control circuit without the voltage circuit structure of the present invention (FIG. 3A) and with the voltage circuit structure of FIG. 2A (FIG. 3B).

### DESCRIPTION OF THE PREFERRED EMBODIMENT

In one aspect of the present invention, the present invention features an igniter control circuit 100 that reduces the line voltage to an igniter 102 and which maintains the igniter voltage relatively stable. More particularly, there is featured a thyristor-based phase control circuit that reduces the RMS voltage being applied to an igniter 102 when it is connected to the AC line 104 or line voltage. Such an igniter control circuit 100 also is configured so that it opposes changes in line voltage such that the igniter voltage remains relatively stable when the line voltage increases or decreases relative to its nominal level.

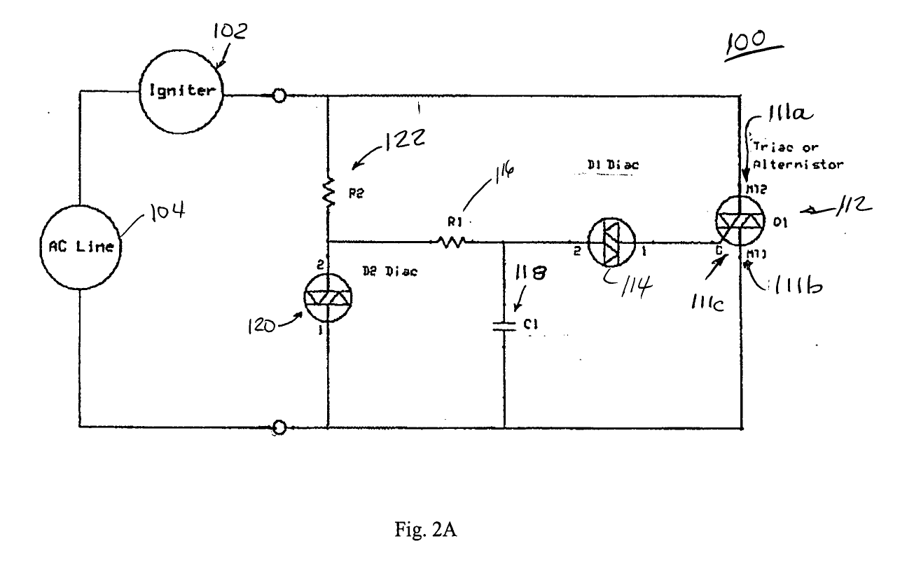

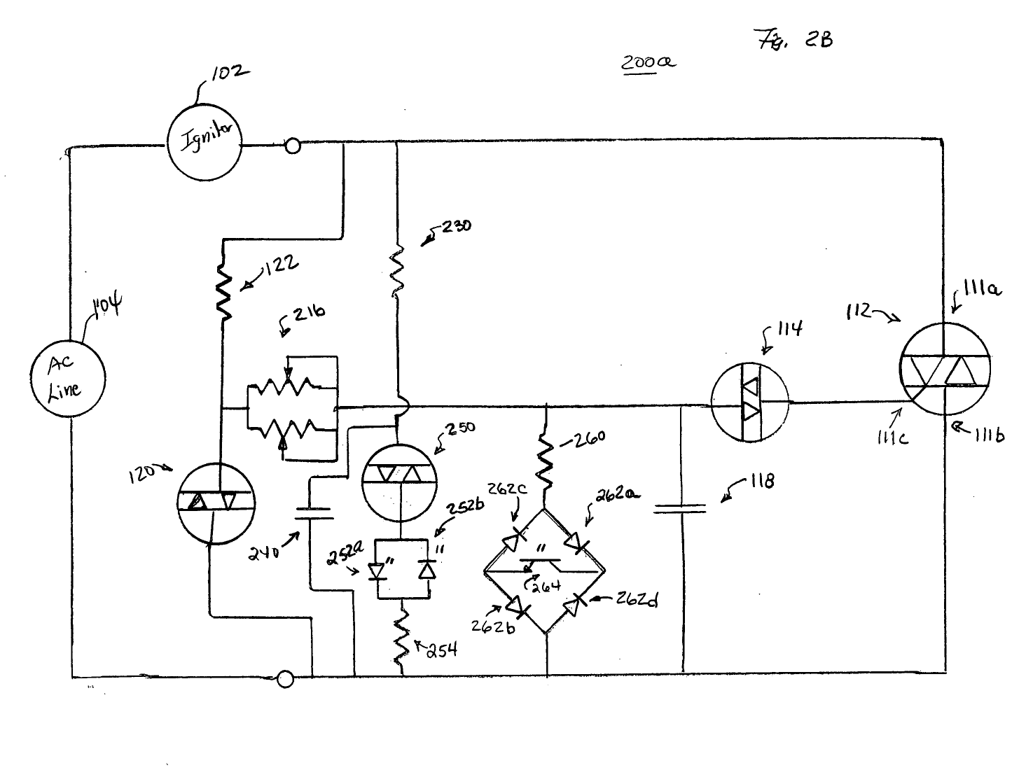

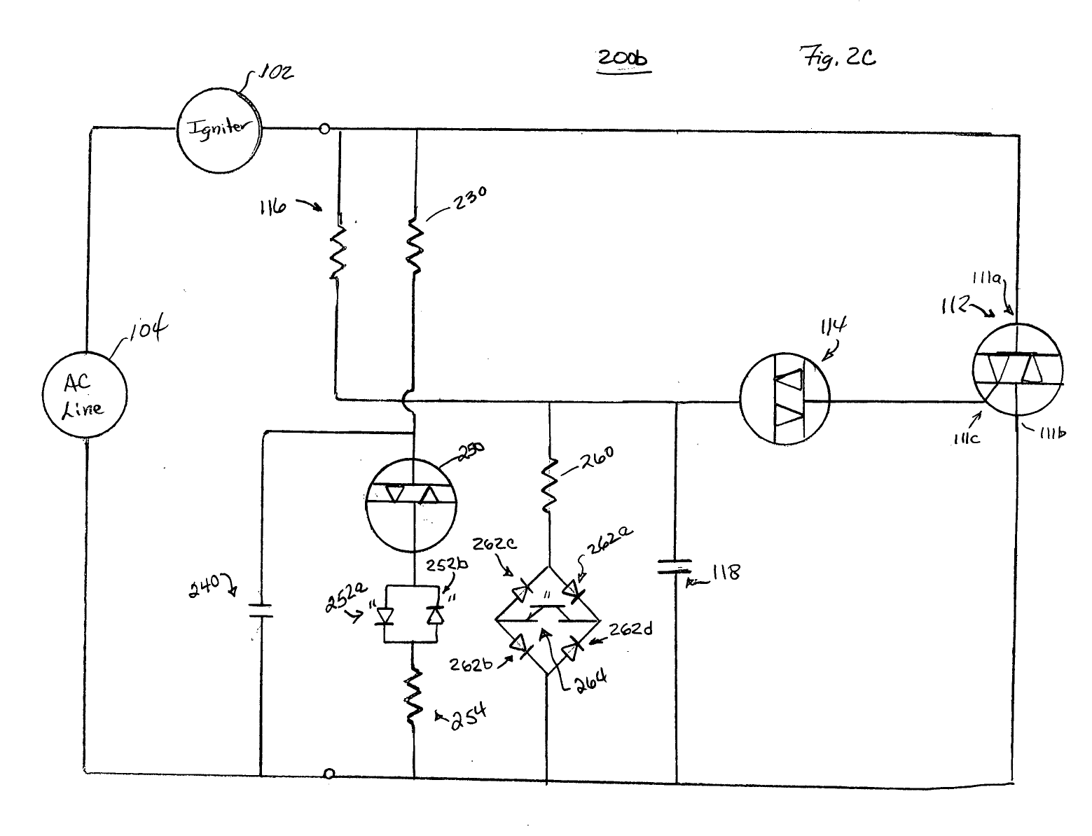

Referring now to the various figures of the drawing wherein like reference characters refer to like parts, there is a shown in FIG. 2A a schematic view of a thyristor-based phase control circuit 100, more particularly a Dual-Diac thyristor-based phase control circuit, for an igniter 102 according to the present invention. Such a control circuit 100 reduces the RMS voltage applied to the igniter 102 when the igniter is connected to the AC line 104 or line voltage so the voltage being applied to the igniter is appropriate for the igniter. Such a control circuit as herein described also is configured so as to oppose changes in line voltage, whereby the igniter voltage remains relatively stable when the line voltage increases or decreases relative to its nominal level.

The control circuit 100 of the present invention includes a triac 112 or alternistor, a first diac 114, a first resistor 116, capacitor 118, a second diac 120 and a second resistor 122, which are arranged as shown in FIG. 2A. In the control circuit 100, the first and second diacs 114, 120 and the triac 112 are initially in a high-resistance state and thus current is not allowed to flow. The first resistor 116 and the capacitor 118 are arranged to form a series RC circuit.

When the capacitor 118 charges to the “breakover voltage” (V_{Bo}) of the first diac 114, the resistance of the diac suddenly drops such that much of the charge on the capacitor 118 is dumped into the gate 111c of the triac 112 to fire (i.e., switch on) and thus apply current to the igniter 102. When the triac 112 switches on, the resistance between terminals MT2 111a and MTI 111b drops to a very low level. When the first diac's current drops below its “holding” current, when the charge in the capacitor 118 becomes depleted, the first diac 114 reverts back to its high-resistance state. Similarly, when the triac's current drops below its “holding” current when the line voltage nears zero again, the triac 112 reverts back into its high-resistance state.

Since the first diac 114 and triac 112 are AC devices, the same series of events occurs during the negative half of the AC cycle. Thus, the igniter 102 is only on during a fraction of each AC cycle, and the size of that fraction is mainly determined by the value of the first resistor 116. The value of the capacitor 118 is typically fixed in order to fix the amount of charge dumped into the gate of the triac 112.

The control circuit 100 includes a second resistor 122 and the second diac 120 to form what is called a Dual-Diac configuration. As described herein, such a Dual-Diac configuration forms a control circuit that can reduce the voltage being applied to the igniter and also oppose changes to line voltage such that the line voltage exaggeration effects seen with conventional control circuitry that embodies a single diac are minimized or mitigated.

As the second diac 120 exhibits negative resistance when it drops to its low resistance state, once the second diac 120 reaches its “breakover voltage” or V_{BO}, its voltage will immediately drop. As the voltage will drop further thereafter, the voltage will drop further even as the line voltage increases. In the configuration of the present invention, the first resistor 116 and the capacitor 118 are fed by the voltage across the second diac 120 (whereas in contrast the diac is fed line voltage). Also, with this configuration the charging rate of the capacitor 118 is reduced as the line voltage increases. This negative feedback provides a mechanism to stabilize the igniter voltage when the line voltage changes.

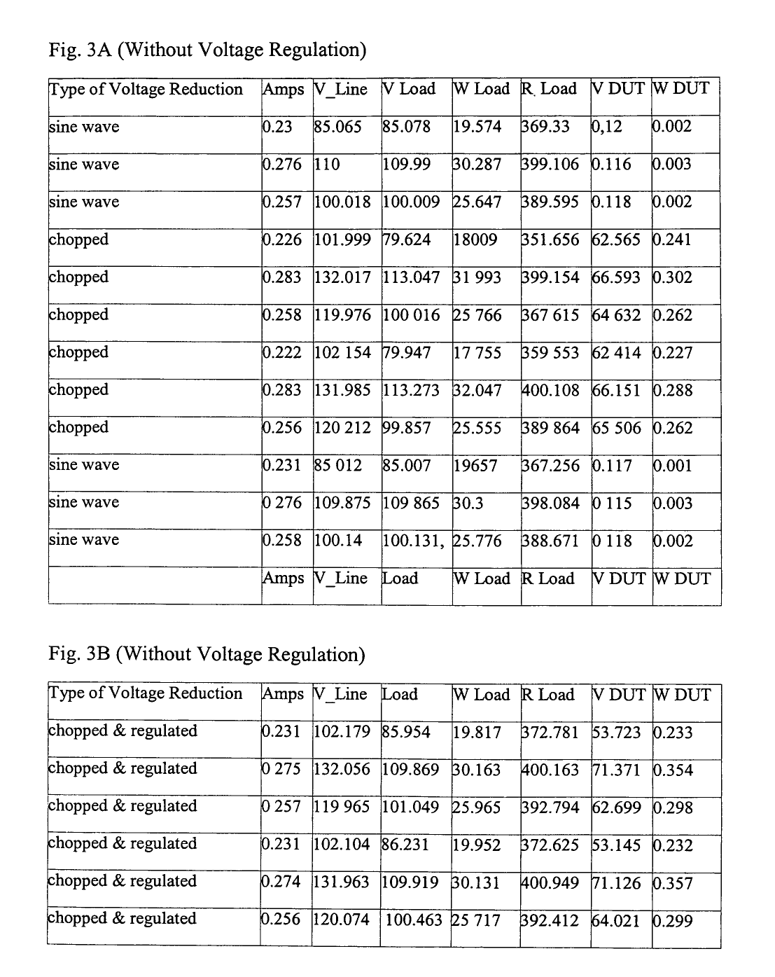

A conventional thyristor-based phase control circuit and a thyristor-based phase control circuit 100 were prototyped, and preliminary testing in conjunction with a 100 Volt igniter was conducted (see FIG. 3). In particular, such preliminary testing was conducted to compare these circuits using three igniter voltage reduction methods; method 1—sine wave control using variable auto transformer method; method 2—chopped (phase control) using Quadrac/R/C and method 3—chopped and regulated using Triac/Diac/Diac/R/R/C. The test station was a portable unit which utilized Ni LabView, NI 9215 DAQ module, and Honeywell CSNE151 current sensor.

In the test circuits an adjustable resistor (i.e., potentiometer) was used in the prototypes to make the output voltage variable—and therefore adaptable to igniters with different voltage requirements. It is within the scope of the present invention, for the first resistor to be a fixed type for use with a specific igniter, for example.

Referring now to FIG. 2B, there is a shown a schematic view of a thyristor-based phase control circuit 200a according to another aspect of the present invention. Such a control circuit 200a reduces the RMS voltage applied to the igniter 102 when the igniter is connected to the AC line 104 or line voltage so the voltage being applied to the igniter is appropriate for the igniter. Such a control circuit 200a also is configured so as to oppose changes in line voltage, whereby the igniter voltage remains relatively stable when the line voltage increases or decreases relative to its nominal level.

More particularly, the control circuit 200a of this embodiment embodies both Dual-Diac circuitry and relaxation oscillator circuitry to reduce the RMS voltage applied to the igniter 102, so the applied voltage is appropriate for the igniter, and also so as to oppose changes in line voltage, when the line voltage increases or decreases relative to its nominal level. In a particular illustrative embodiments, such a control circuit 200a includes a triac 112, a first diac 114, a first resistor 216, a first capacitor 118, a second diac 120 and a second resistor 122, much the same as described herein for the control circuit shown in FIG. 2A. Thus, reference should be made to the discussion provided in connection with FIG. 2A for these circuit elements and the manner in which each functions in that control circuit except as otherwise described below.

In the illustrated embodiment, the first resistor 216 is depicted as being composed of two potentiometers that are arranged in parallel. This arrangement provides a level of adjustability whereby the resistance of the first resistor 216 can be adjusted so the control circuit 200a, can be used with any of a number of different types or sizes of igniters as well as to compensate for other circuit or line voltage conditions or variations. The illustrative embodiment shall not be considered as limiting, however, as it is within the skill of those in the art to determine the value of the resistance to be developed by the first resistor for a particular igniter and providing one or more resistors having a fixed resistance value in place of the illustrated two potentiometers, such as that illustrated in FIGS. 2A, C. As indicated above, reference shall be made to the discussion regarding the resistor 116 of FIG. 2A for other details not provided herein.

As indicated above, the control circuit 200a also is configured to embody relaxation oscillator circuitry. In this illustrative embodiment, the relaxation oscillator circuitry includes a third resistor 230, a second capacitor 240, a third diac 250, photodiodes 252a,b, and a fourth resistor 254, which are configured, arranged and sized so that the relaxation oscillator frequency increases or decreases with line voltage.

When the second capacitor 240 is charged to the “breakover voltage” (V_{Bo}) of the third diac 250, the resistance of the diac suddenly drops such that much of the charge on the second capacitor flows through one of the photodiodes 252a,b causing light to be outputted therefrom. The photodiodes 252a,b are arranged so that one photodiode 252a provides the light output light during the positive portion of the AC voltage cycle and the other photodiode 252b provides the light output light during the negative portion of the AC voltage cycle. The fourth resistor 254 is sized so as to provide over current protection to the photodiodes 252a,b.

When the third diac's current drops below its “holding” current, when the charge in the second capacitor 240 becomes depleted, the third diac 250 reverts back to its high-resistance state and the capacitor again begins to charge. The second capacitor 240 and the third resistor 230 are arranged and sized such that the second capacitor charges up many times during each half cycle and the above-described process occurs many times during each of the half-cycles. The number of pulses per each half cycle or the rate thereof depends upon line voltage. Thus, if the line voltage increases above the nominal value, the number of pulses created per second and thus the oscillator frequency is increased and correspondingly if the line voltage decreases below the nominal value, the number of pulses created per second and thus the oscillator frequency is decreased.

The control circuit 200a of this embodiment further includes a photosensitive transistor 264, four diodes 262a-d and a fifth resistor 260. The photosensitive transistor 264 is any of a number of devices known to those skilled in the art, which conducts or is turned on in the presence of light. As is known to those skilled in the art, the photodiodes 252a,b and the photosensitive transistor 264 can be contained in a conventional AC input optocoupler.

This selective repetitive operation of the third diac 250 in combination with the rate in which the second capacitor is charged, causes current spikes to be created that pass through one of the photodiodes 252a,b during each half of the AC cycle. The light emanating from the one of the photodiodes 252a,b is received by the photosensitive transistor 264, thereby causing the photosensitive transistor to conduct. The energy in each spike is relatively constant and thus the light energy being outputted by each of the photodiodes 252a,b is also relatively constant. Correspondingly, the conduction time of the photosensitive transistor 264 is relatively constant during each spike.

The photosensitive transistor 264 is disposed at a midpoint between four diodes 262a-d that are arranged in a diode bridge type of configuration. Thus, when the photosensitive transistor 264 is turned on or put into a conducting state, charging current is bleed through the fifth resistor 260 and thence through the appropriate pair of photodiodes and the conducting photosensitive transistor and thus is taken from the charging circuit of the first capacitor 118. The diodes 262a-d are arranged to form two pairs of diodes (262a,b; 262c,d) such that current is conducted away from the first capacitor's charging circuit in both the positive and negative half cycle's of the AC cycle.

This bleeding of current in turn affects the rate at which the first capacitor is charged, which in turn further regulates the turn on time of the triac 112 during each half cycle. Since an increase in line voltage cause an increase of the spike rate in the oscillator circuitry, this also causes an increase in the delay of the triac 112 turning on and which reduces the conduction time for the load.

Referring now to FIG. 2C, there is a shown a schematic view of a thyristor-based phase control circuit 200b according to yet another aspect of the present invention. Such a control circuit 200b reduces the RMS voltage applied to the igniter 102 when the igniter is connected to the AC line 104 or line voltage so the voltage being applied to the igniter is appropriate for the igniter. Such a control circuit 200b also is configured so as to oppose changes in line voltage, whereby the igniter voltage remains relatively stable when the line voltage increases or decreases relative to its nominal level. In this embodiment, the control circuit 200b embodies relaxation oscillator circuitry to reduce the RMS voltage applied to the igniter 102, so the applied voltage is appropriate for the igniter, and also so as to oppose changes in line voltage, when the line voltage increases or decreases relative to its nominal level.

In a particular illustrative embodiments, such a control circuit 200b includes a triac 112, a first diac 114, a first resistor 116, a first capacitor 118, a third resistor 230, a second capacitor 240, a third diac 250, photodiodes 252a,b, and a fourth resistor 254, a photosensitive transistor 264, four diodes 262a-d and a fifth resistor 260. Reference shall be made to the discussion provided regarding FIG. 2b for these circuit elements and the manner in which each functions in the control circuit except as otherwise describe below.

As with the above-described embodiment of FIG. 2B, the relaxation oscillator circuitry is composed of the third resistor 230, the second capacitor 240, the third diac 250, the photodiodes 252a,b, and the fourth resistor 254, which are configured, arranged and sized so that the relaxation oscillator frequency increases or decreases with line voltage. As also indicated above, the photosensitive transistor 264, four diodes 262a-d and a fifth resistor 260 in combination with the light outputs from the photodiodes 252a,b operate so as to bleed or take away charging current to the first capacitor 118. As also described herein, the frequency of the relaxation oscillator is dependent upon the line voltage. Thus, the frequency of the relaxation oscillator is responsively changed so as to oppose changes in the line voltage affecting voltage and power from the triac 112 to the igniter 102.

In this embodiment, the control circuit 200b selectively and repetitively bleeds charging current from the first capacitor 118 to regulate the rapidity with which the first capacitor 118 can be charged to the breakover voltage of the first diac 114. The control circuitry 220b also uses the relaxation oscillator circuitry's capability to adjust the number of spikes being created per unit time responsive to changes in line voltage to control such bleeding of charging current.

The above described circuits of the present invention are advantageous in a number of respects. The thyristor-based phase control switches the load current on and off in order to reduce the RMS load voltage. As an ideal switch consumes no power, this technique can be very efficient. High efficiency also means that there is less heat to dissipate. This allows the circuit to be compact, and thereby makes it feasible to actually house the circuit inside of the igniter connector. The dual-Diac configuration of the circuit provides improved load voltage stability. This translates into improved igniter ignition performance, and longer igniter life in applications that are routinely subject to line voltage variations.

It also is within the scope of the present invention to further reduce size of the circuit package by selecting a smaller package size for the triac and/or moving to surface mount technology. Once installed within an igniter connector, further heat removal can be effected by potting the circuit in a thermally conductive material and/or adding one or more pins to the connector to conduct heat away from the electronic components.

In further aspects of the present invention, there is featured a method for controlling the voltage being applied to an igniter. Such methods include the methodology embodied in the above-described circuits of the preset invention.

In more particular embodiments, such methods include providing a control circuit having any one of the circuit configurations described herein including the dual diac configuration, the relaxation oscillator configuration or a control circuit embodying both a dual diac configuration and a relaxation oscillator configuration. Such methods more particularly include providing a circuit arrangement to control the charging of the capacitor so as to thereby control the voltage being applied to the triac when the first diac fires.

Such control circuits of the present invention also are adaptable for use with certain motors so as to provide speed stabilization under varying line voltage conditions. In such a case, the control circuit would be connected to existing motor control circuitry so as to maintain the voltage being applied to the motor windings so that when line voltage is increased above a nominal value, the speed of the motor is not thereby increased. Such methods also include methods for controlling the speed of the motor.

Although a preferred embodiment of the invention has been described using specific terms, such description is for illustrative purposes only, and it is to be understood that changes and variations may be made without departing from the spirit or scope of the following claims.

### INCORPORATION BY REFERENCE

All patents, published patent applications and other references disclosed herein are hereby expressly incorporated by reference in their entireties by reference.

### EQUIVALENTS

Those skilled in the art will recognize, or be able to ascertain using no more than routine experimentation, many equivalents of the specific embodiments of the invention described herein. Such equivalents are intended to be encompassed by the following claims.

What is claimed is:

1. A voltage control circuit for an igniter for controlling voltage being applied to the igniter, said voltage control circuit comprising:
a triac;
a first diac electrically coupled to the triac such that current is provided to the triac when the first diac fires;
an RC circuit element in which the capacitor is arranged to feed voltage to the first diac; and
a resistor/diac element in which the voltage from such an element is supplied to the RC element for charging a capacitor.

2. The voltage control circuit of claim 1, wherein the RC circuit element includes a first resistor and capacitor in series arrangement.

3. The voltage control circuit of claim 1, wherein the resistor/diac element includes a second resistor and a second diac in series arrangement.

4. The line voltage control circuit of claim 3, wherein the second resistor and the second diac are connected in series so as to be across a source of line voltage.

5. The line voltage control circuit of claim 3, wherein the RC circuit element includes a first resistor and a capacitor arranged so as to be in series and being connected to a point electrically between the second resistor and the second diac.

6. The line voltage control circuit of claim 1, further comprising:
a relaxation oscillator circuit that is configured to repetitively create N signal outputs during each half AC cycle of the line voltage source, N is an integer greater than 2; and
a bleed circuit operably coupled to the relaxation oscillator circuit and operably coupled to the RC circuit element, wherein the bleed circuit is configured and arranged so as to reduce an amount of charge being provided to the capacitor of the RC element responsive to the output signals of the relaxation oscillator circuit.

7. A voltage control circuit for an igniter for controlling voltage being applied to the igniter, said voltage control circuit comprising:
a triac;
a first diac electrically coupled to the triac such that current is provided to the triac when the first diac fires;
an RC circuit element including a first resistor and a first capacitor that are arranged so as to be in series, where the first capacitor is arranged to feed voltage to the first diac;
a resistor/diac element including a second resistor and a second diac arranged so as to be in series, where voltage from such an element is supplied to the first capacitor for charging of the first capacitor;
wherein the second resistor and the second diac are arranged in the circuit so as to be across a source of line voltage; and
wherein the RC circuit element are arranged so as to be connected to a point electrically between the second resistor and the second diac.

8. The line voltage control circuit of claim 7, further comprising:
a relaxation oscillator circuit that is configured to repetitively create N signal outputs during each half AC cycle of the line voltage source, N is an integer greater than 2; and
a bleed circuit operably coupled to the relaxation oscillator circuit and operably coupled to the RC circuit element, wherein the bleed circuit is configured and arranged so as to reduce an amount of charge being provided to the first capacitor responsive to the output signals of the relaxation oscillator circuit.

9. An ignition system electrically coupled to a voltage source, comprising:
an igniter;
a voltage control circuit electrically coupled to the igniter for controlling the voltage being applied to the igniter, and
wherein said voltage control circuit includes:
a triac,
a first diac electrically coupled to the triac such that current is provided to the triac when the diac fires,
an RC circuit element in which the capacitor is arranged to feed voltage to the first diac, and
an resistor/diac element in which the voltage from such an element is supplied to the RC element for charging of the capacitor.

10. The system of claim 9, wherein the RC circuit element includes a first resistor and capacitor arranged so as to be in series.

11. The system of claim 9, wherein the resistor/diac element includes a second resistor and a second diac arranged so as to be in series.

12. The system claim 11, wherein the second resistor and the second diac are connected in series and so as to be across a source of line voltage.

13. The system of claim 11, wherein the RC circuit element includes a first resistor and capacitor arranged so as to be in series and are connected to a point electrically between the second resistor and the second diac.

14. The system of claim 9, wherein said voltage control circuit further includes:
a relaxation oscillator circuit that is configured to repetitively create N signal outputs during each half AC cycle of the line voltage source, N is an integer greater than 2; and
a bleed circuit operably coupled to the relaxation oscillator circuit and operably coupled to the RC circuit element, wherein the bleed circuit is configured and arranged so as to reduce an amount of charge being provided to the first capacitor responsive to the output signals of the relaxation oscillator circuit.

15. A method for controlling voltage being applied to an igniter; comprising the steps of:
providing a first circuit element that is configured so voltage being applied to the igniter is at about a nominal value; and
regulating inputted line voltage using the first circuit element so as to mitigate changes in line voltage causing changes in voltage being applied to the igniter.

16. The method of claim 15, further comprising the steps of:
providing a second circuit element that is configured to adjust the voltage being applied to the igniter so as to be at a voltage less than the inputted line voltage; and
adjusting the inputted line voltage so as to be at about a desired voltage to be applied to the igniter.

17. The method of claim 16, wherein;
said providing first and second circuit elements includes providing a voltage control circuit; and
said method further includes the step of:
electrically coupling the voltage control circuit to the igniter,

18. The method of claim 15, wherein the provided voltage control circuit includes:
a triac,
a first diac electrically coupled to the triac such that current is provided to the triac when the first diac fires,
an RC circuit element in which the capacitor is arranged to feed voltage to the first diac, and
a resistor/diac element in which the voltage from such an element is supplied to the RC element for charging of the capacitor.

19. The method of claim 17, wherein the RC circuit element includes a first resistor and capacitor in series arrangement.

20. The method of claim 18, wherein the resistor/diac element includes a second resistor and a second diac in series arrangement.

21. The method of claim 20, wherein the second resistor and the second diac are connected in series so as to be across a source of line voltage.

22. The method of claim 20, wherein the RC circuit element includes a first resistor and capacitor in series arrangement and are connected to a point electrically between the second resistor and the second diac.

23. The method of claim 17, circuit of claim 6, wherein said providing includes providing:
a relaxation oscillator circuit that is configured to repetitively create N signal outputs during each half AC cycle of the line voltage source, N is an integer greater than 2; and
a bleed circuit operably coupled to the relaxation oscillator circuit and operably coupled to the RC circuit element, wherein the bleed circuit is configured and arranged so as to reduce an amount of charge being provided to the first capacitor responsive to the output signals of the relaxation oscillator circuit.

24. A method for regulating speed of a motor; comprising the steps of:
providing a first circuit element that is configured so as to control voltage being applied to the motor so it is maintained at about a nominal value; and
regulating line voltage being inputted to the motor using the first circuit element so as to mitigate changes in line voltage causing changes in voltage being applied to the motor.

25. A voltage control circuit for an igniter for controlling voltage being applied to the igniter, said voltage control circuit comprising:
a triac;
a first diac electrically coupled to the triac such that current is provided to the triac when the first diac fires;
an RC circuit element including a first capacitor which is arranged to feed voltage to the first diac;
a relaxation oscillator circuit that is configured to repetitively create N signal outputs during each half AC cycle of the line voltage source, N is an integer greater than 2; and
a bleed circuit operably coupled to the relaxation oscillator circuit and operably coupled to the RC circuit element, wherein the bleed circuit is configured and arranged so as to reduce an amount of charge being provided to the first capacitor responsive to the output signals of the relaxation oscillator circuit.

26. The voltage control circuit of claim 25, wherein the RC circuit element includes a first resistor, where the first resistor and the first capacitor are arranged in series.

27. The line voltage control circuit of claim 26, wherein the first resistor and the first capacitor are connected across a source of line voltage.

28. The line voltage control circuit of claim 27, wherein the bleed circuit is connected to a point electrically between the first resistor and first capacitor.

29. The line voltage circuit of claim 25, wherein:
the bleed circuit includes a fifth resistor and a switching element that are arranged so as to be in series;
the switching element is operably coupled to the relaxation oscillator circuit so as to selectively open an close responsive to the relaxation oscillator circuit; and
when an output signal is received from the relaxation oscillator circuit, the switching element causes current to be drawn through the fifth resistor and away from the first capacitor.

30. The line voltage circuit of claim 29, wherein the relaxation oscillator circuit includes:
an RC circuit element including a third resistor and a second capacitor, the third resistor and capacitor being configured and arranged so the second capacitor is capable of being charged N times during each half AC cycle of the line voltage source, N being an integer greater than 2.

31. The line voltage circuit of claim 30, wherein the relaxation oscillator circuit further includes:
a third diac;
at least one photodiode; and a fourth resistor; and
wherein the third diac, the at least one photodiode and the fourth resistor are arranged so as to be in series.

32. The line voltage circuit of claim 28, wherein the series arrangement of the third diac, the at least one photodiode and the fourth resistor is arranged so as to be in parallel arrangement with the second capacitor.

33. The line voltage circuit of claim 32, wherein:
the bleed circuit switching element includes a photosensitive transistor;
the at least one photodiode of the relaxation oscillator circuit is optically coupled to the photosensitive transistor; and
the photosensitive transistor causes the switching element to selectively open and close responsive to the optical signals generated by the at least one photodiode.

34. The line voltage circuit of claim 33, wherein:
the relaxation oscillator circuit further includes a plurality of photodiodes that are both optically coupled to the photosensitive transistor, where one photodiode is configured to output optical signals during a half AC cycle of the line voltage source and the other photodiode is configured to output optical signals during the other half AC cycle of the line voltage source; and
the switching element includes a plurality of diodes that are arranged so that current flows through the fifth resistor during either of the two half AC cycles.

35. The line voltage circuit of claim 34, wherein:
when the second capacitor is charged to the breakover voltage of the third diac, the third diac fires causing current to flow through each of the at least one photodiodes thereby causing an optical signal to be outputted therefrom; and
when the third diac's current drops below its holding current, the third diac reverts to its high-resistance state and the second capacitor again begins to charge.

36. The line voltage circuit of claim 28, wherein:
the bleed circuit includes a fifth resistor and a switching element that are arranged so as to be in series, the switching element including a photosensitive transistor;
the relaxation oscillator circuit further includes:
a third resistor,
a second capacitor, the third resistor and capacitor being configured and arranged so the second capacitor is capable of being charged N times during each half AC cycle of the line voltage source,
a third diac,
a plurality of photodiode; and a fourth resistor,
the third diac, the at least one photodiode and the fourth resistor are arranged so as to be in series and the series arrangement of the third diac, the at least one photodiode and the fourth resistor is arranged so as to be in parallel arrangement with the second capacitor, and
each of the plurality of photodiodes being optically coupled to the photosensitive transistor; and
the photosensitive transistor causes the switching element to selectively open and close responsive to the optical signals generated by said each of the plurality of photodiodes, where when an optical signal is received, the switching element causes current to be drawn through the fifth resistor and away from the first capacitor.

37. The line voltage circuit of claim 36, wherein:
one of the plurality of photodiode is configured to output optical signals during one half AC cycle of the line voltage source and the other of the plurality of photodiodes is configured to output optical signals during the other half AC cycle of the line voltage source; and
the switching element includes a plurality of diodes that are arranged so that current flows through the fifth resistor during either of the two half AC cycles.

38. The line voltage circuit of claim 37, wherein:
when the second capacitor is charged to the breakover voltage of the third diac, the third diac fires causing current to flow through a respective one of the plurality of photodiodes thereby causing an optical signal to be outputted therefrom; and
when the third diac's current drops below its holding current, the third diac reverts to its high-resistance state and the second capacitor again begins to charge.
